(19) United States
(12) Patent Application Publication
(10) Pub. No.: US 2005/0141364 A1
(43) Pub. Date: Jun. 30, 2005

(54) Objective lens drive device and optical head device provided therewith

(75) Inventors: Yoshifusa Miyasaka, Nagano (JP); Tatsuki Wade, Nagano (JP); Izumi Onozawa, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 11/016,694

(22) Filed: Dec. 17, 2004

(30) Foreign Application Priority Data
Dec. 25, 2003 (JP) 2003-429027
Jul. 30, 2004 (JP) 2004-223848
Dec. 9, 2004 (JP) 2004-356099

(51) Int. Cl. G11B 7/00

(52) U.S. Cl. 369/44.32; 369/44.15

(57) ABSTRACT

An objective lens drive device includes an objective lens, a lens holder holding the objective lens, a fixed side member supporting the lens holder with a plurality of wires in a movable manner, a focusing and tracking drive mechanism, and a tilt drive mechanism for driving the lens holder in a tilt direction. The tilt drive mechanism includes at least a tilt drive coil disposed at one place which is mounted on either side of the lens holder and the fixed side member and at least a tilt drive magnet disposed at one place so as to be opposed to the tilt drive coil on an other side of the lens holder and the fixed side member.

### BACKGROUND OF THE INVENTION

1. Field of the Invention

The present invention relates to a so-called wire suspension type of objective lens drive device and an optical head device provided with the objective lens drive device.

2. Description of Related Art

As an optical head device which is used for recording on or reproducing from an optical recording disk such as a CD or a DVD, an optical head device provided with a so-called wire suspension type of objective lens drive device has been known which includes an objective lens, a lens holder which holds the objective lens, a fixed side member which movably supports the lens holder with a plurality of wires, a focusing and tracking drive mechanism which drives the lens holder in a focusing direction and in a tracking direction, and a tilt drive mechanism which drives the lens holder in a tilt direction.

One of the objective lens drive device used in the optical head device includes the tilt drive mechanism which is constructed of one tilt drive coil and one pair (two) of separated tilt drive magnets.

Alternatively, another tilt drive mechanism is also used which is constructed of one pair of separated tilt drive coils and one pair of separated tilt drive magnets.

In recent years, the downsizing of the entire optical head device has been required in order to mount the head device in a notebook-size personal computer and therefore the miniaturization of an objective lens drive device which is incorporated into the optical head device is also required.

However, in the objective lens drive device having the conventional tilt drive mechanism, at least a pair of tilt drive magnets are required to be separately mounted and thus the miniaturization of the objective lens drive device is difficult. In addition, since a pair of tilt drive magnets is mounted, the cost of the device can not be reduced.

### SUMMARY OF THE INVENTION

In view of the problems described above, it is advantage of the present invention to provide a wire suspension type of objective lens drive device having a tilt drive mechanism, which is capable of simplifying the construction of the tilt drive mechanism to prevent the size of the device from becoming larger.

In order to achieve the above advantage, according to the present invention, there is provided an objective lens drive device including an objective lens, a lens holder which holds the objective lens, a fixed side member which supports the lens holder with a plurality of wires in a movable manner, a focusing and tracking drive mechanism which drives the lens holder in a focusing direction and in a tracking direction, and a tilt drive mechanism which drives the lens holder in a tilt direction. The tilt drive mechanism includes at least a tilt drive coil disposed at one place which is mounted on either side of the lens holder and the fixed side member and at least a tilt drive magnet disposed at one place so as to be opposed to the tilt drive coil on the other side of the lens holder and the fixed side member. The plurality of wires in the embodiment of the present invention may use not only a normal round bar-shaped wire but also a plate-shaped bar that is formed in a thin plate, a rectangular plate bar or the like. In other words, the cross-sectional shape of the wire is not limited to a circular shape but also to a rectangular shape.

In accordance with an embodiment of the present invention, the tilt drive magnet disposed at one place is preferably one piece of magnet which is disposed so as to be opposed to the tilt drive coil. Alternatively, the tilt drive magnet disposed at one place may be constructed by using a plurality of mono polar magnets which are integrated into one piece or positioned in a close relation.

In accordance with an embodiment of the present invention, the tilt drive coil disposed at one place is preferably one piece of coil which is disposed so as to be opposed to the tilt drive magnet. Alternatively, the tilt drive coil may include two coils which are disposed so as to be opposed to the tilt drive magnet and are connected to be in reverse directions to each other. Further, the tilt drive coil may include a plurality of coils which are connected to be in the same direction as each other. When the tilt drive coil includes two coils which are connected to be in reverse directions to each other, the tilt drive magnet may be magnetized in only two poles. When the tilt drive coil includes a plurality of coils which are connected to be in the same direction as each other, the tilt drive magnet is required to have four magnetized parts but the plurality of coils are not required to be wound in the reverse direction.

In accordance with an embodiment of the present invention, the tilt drive coil is wound around such that an opposing face to the tilt drive magnet is formed in a rectangular shape which has longitudinal side parts and traverse side parts. The tilt drive magnet is provided with four magnetized parts on an opposing face to the tilt drive coil, which are polarized and magnetized in four poles by polarized lines which are parallel with the longitudinal side part and the traverse side part such that an N-pole and an S-pole are alternately magnetized in the four magnetized parts along the winding direction of the tilt drive coil. The longitudinal side part and the traverse side part are respectively arranged so as to extend over two magnetized parts among the four magnetized parts. According to the construction described above, the tilt drive mechanism can be realized by using only one piece of tilt drive magnet opposed to one piece of drive coil without a pair of conventional separated tilt drive magnets.

In accordance with an embodiment of the present invention, the tilt drive coil includes a traverse side part which is formed in parallel with the tracking direction in which the lens holder is driven. The tilt drive magnet includes an N-pole and an S-pole which are magnetized in the focusing direction in which the lens holder is driven. An electric current is supplied to the traverse side part such that forces in reverse directions in the focusing direction in which the lens holder is driven are relatively generated between the tilt drive magnet and the tilt drive coil in the traverse side part of the tilt drive coil to drive the lens holder in a tilt direction. According to the construction described above, the lens holder can be driven in the tilt direction by using the tilt drive coil disposed at one place and the tilt drive magnet disposed at one place.

In accordance with an embodiment of the present invention, the tilt drive coil is one piece of coil which is wound around such that an opposing face to the tilt drive magnet is formed in a rectangular shape which has longitudinal side parts and the traverse side parts. The tilt drive magnet is provided with four magnetized parts on an opposing face to the tilt drive coil, which are polarized and magnetized in four poles by polarized lines which are parallel with the longitudinal side part and the traverse side part. The magnetized parts of the tilt drive magnet corresponding to both sides of the traverse side parts in the tracking direction of the tilt drive coil are magnetized to be in reverse polarities in the focusing direction in which the lens holder is driven. When an electric current is supplied to the one piece of coil, forces in reverse directions with respect to the focusing direction in which the lens holder is driven are relatively generated between the tilt drive magnet and the tilt drive coil on both sides of the traverse side parts in the tracking direction of the tilt drive coil. In this case, the traverse side part of the tilt drive coil is preferably arranged such that the polarized line which is parallel to the longitudinal side part of the tilt drive magnet is positioned at a center position of the traverse side part in the tracking direction. According to the construction described above, the lens holder can be driven in the tilt direction by using one piece of the tilt drive coil and the tilt drive magnet disposed at one place. In this case, the tilt drive magnet having four magnetized parts may be constructed of one piece of magnet or constructed such that four magnets may be arranged at one place.

In accordance with an embodiment of the present invention, the opposing face of the tilt drive magnet to the tilt drive coil includes two magnetized parts which are polarized and magnetized in two poles by a polarized line that is parallel with the traverse side part. The tilt drive coil includes two coils which have the traverse side parts so as to be opposed to the tilt drive magnet and are arranged side by side in the tracking direction. The traverse side parts of the two coils arranged so as to be opposed to a magnetized part of same polarity are electrically connected so that electric currents in reverse directions are supplied to the traverse side parts of the two coils. According to the construction described above, when electric currents in reverse directions are respectively supplied to the traverse side parts of the two coils, forces in reverse directions with respect to the focusing direction in which the lens holder is driven can be relatively generated between the tilt drive magnet and the two tilt drive coils.

In accordance with an embodiment of the present invention, the tilt drive magnet includes four magnetized parts on an opposing face to the tilt drive coil, which are polarized and magnetized in four poles by polarized lines which are parallel to the longitudinal side part and the traverse side part. The tilt drive coil includes two coils, each of which is wound around such that an opposing face to the tilt drive magnet is formed in a rectangular shape which has longitudinal side parts and the traverse side parts, and which are arranged side by side in the tracking direction such that magnetized parts polarized by the polarized line parallel with the longitudinal side part of the tilt drive coil are respectively opposed to the two coils. The traverse side parts of the two coils are connected to each other so that electric currents in the same direction are supplied to the traverse side parts of the two coils, and the magnetized parts of the tilt drive magnet which are opposed to the traverse side parts of the two coils are magnetized in reverse polarities in the focusing direction in which the lens holder is driven. According to the construction described above, when electric currents are respectively supplied to the two coils, forces in reverse directions with respect to the focusing direction are relatively generated between the tilt drive magnet and the two tilt drive coils. Furthermore, a third coil may be provided between the two coils in the tracking direction. In this case, the traverse side part of the third coil is preferably arranged such that the polarized line which is parallel to the longitudinal side part of the tilt drive magnet is positioned at a center position of the traverse side part in the tracking direction and that an electric current is supplied in the same direction as that in the two coils.

In accordance with an embodiment of the present invention, preferably the objective lens is held on one end side of the lens holder and the tilt drive mechanism is disposed on the other end side of the lens holder. When the objective lens and the tilt drive mechanism are arranged on both end sides of the lens holder of the objective lens drive device, the balance of the objective lens drive device may be easily maintained adequately. Therefore, stable focusing and tracking control can be performed.

In accordance with an embodiment of the present invention, a damper device for restricting resonant vibration of the lens holder is preferably mounted on the lens holder. In this case, the damper device preferably includes an elastic member mounted on the lens holder and the tilt drive coil or the tilt drive magnet mounted on the elastic member. According to the construction described above, the resonant vibration of the lens holder can be absorbed by using the component part of the tilt drive mechanism.

In accordance with an embodiment of the present invention, the tilt drive coil is preferably mounted on the lens holder. Since the tilt drive coil is lighter than the tilt drive magnet, the lens holder can be constructed lighter in comparison with the case that the tilt drive magnet is mounted on the lens holder. As a result, even when the tilt drive mechanism is incorporated into the objective lens drive device, the characteristic deterioration of the objective lens drive device can be restricted. In this case, the tilt drive coil may be energized through wires which support the lens holder.

The objective lens drive device in accordance with the embodiments of the present invention can be applied to an optical head device.

According to the present invention, since the tilt drive mechanism is constructed by using only the tilt drive coil disposed at one place and the tilt drive magnet disposed at one place, the downsizing of the objective lens drive device can be easily attained even when the tilt drive mechanism is incorporated into the objective lens drive device. Further, when the tilt drive coil or the tilt drive magnet is constructed with one piece of coil or one piece of magnet, the number of component parts can be reduced and thus the size and the cost of the optical head device can be reduced.

Other features and advantages of the invention will be apparent from the following detailed description, taken in conjunction with the accompanying drawings that illustrate, by way of example, various features of embodiments of the invention.

### BRIEF DESCRIPTION OF THE SEVERAL VIEWS OF THE DRAWINGS

FIG. 1(A) is a plan view showing an objective lens drive device in accordance with an embodiment of the present invention and

FIG. 1(B) is a side view showing the objective lens drive device shown in FIG. 1(A).

FIG. 2(A) is a plan view showing a lens holder of the objective lens drive device shown in FIGS. 1(A) and 1(B).

FIG. 2(B) is its side view and

FIG. 2(C) is its front view which is viewed from a tilt drive coil side.

FIG. 3(A) is a front view of a tilt drive magnet used in the objective lens drive device shown in FIGS. 1(A) and 1(B) and

FIG. 3(B) is a side view of the tilt drive magnet.

FIG. 4 is an explanatory view showing an arrangement relationship between the tilt drive coil and the tilt drive magnet in which the objective lens drive device in accordance with the embodiment of the present invention is viewed from the tilt drive coil side.

FIG. 5(A) is a front view of a tilt drive magnet in accordance with another embodiment of the present invention and

FIG. 5(B) is a side view of the tilt drive magnet.

FIG. 6 is an explanatory view showing an arrangement relationship between tilt drive coils and the tilt drive magnet in accordance with another embodiment of the present invention in which the objective lens drive device is viewed from the tilt drive coil side.

FIG. 7(A) is a front view of a lens holder used in an objective lens drive device in accordance with another embodiment of the present invention and

FIG. 7(B) is a side view of the lens holder.

FIG. 8 is an explanatory view showing an arrangement relationship between tilt drive coils and the tilt drive magnet in accordance with another embodiment of the present invention.

FIG. 9 is an explanatory view showing an arrangement relationship between tilt drive coils and the tilt drive magnet in accordance with a further embodiment of the present invention.

### DETAILED DESCRIPTION OF THE INVENTION

An objective lens drive device in accordance with an embodiment of the present invention will be described below with reference to the accompanying drawings.

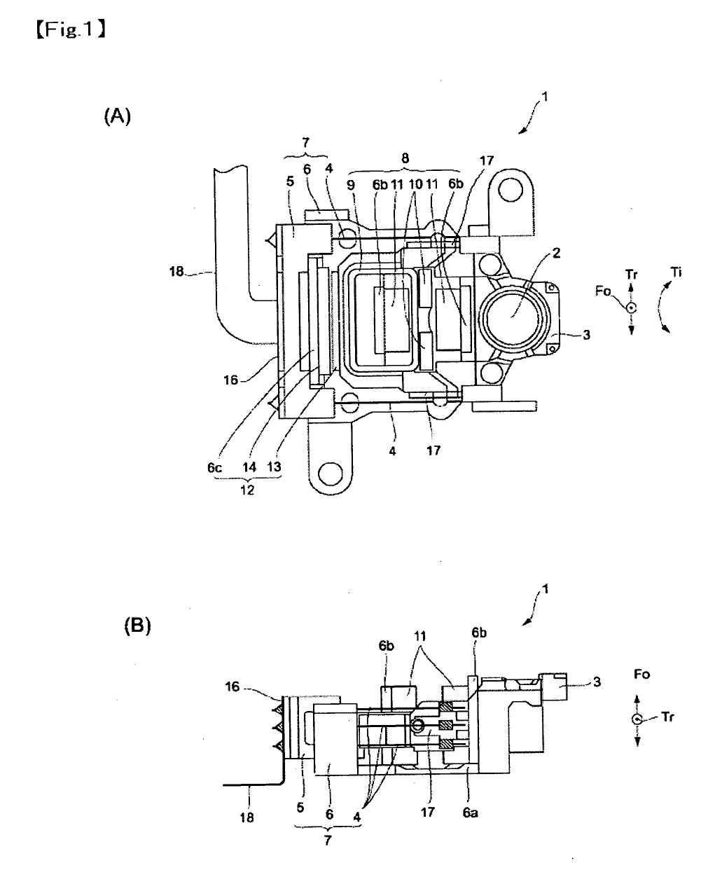

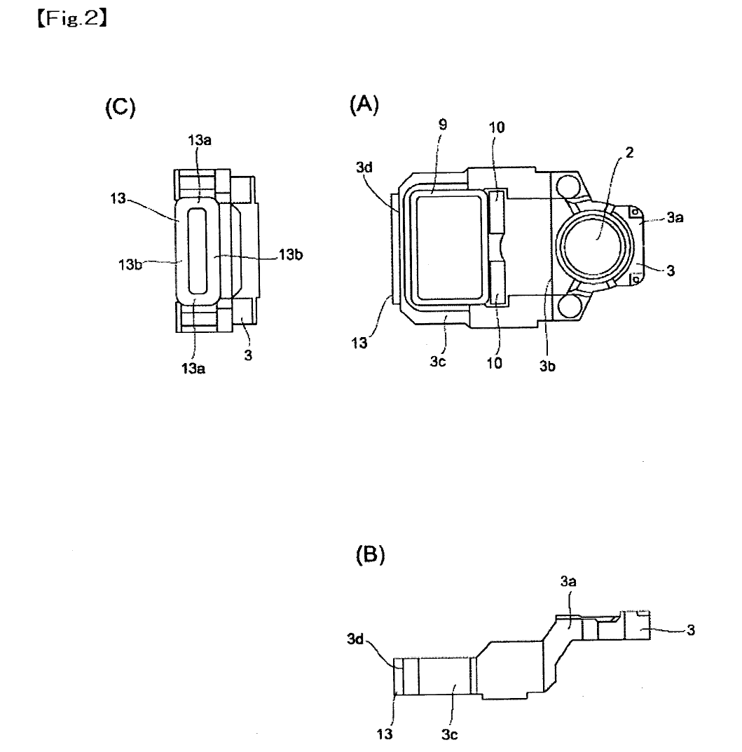

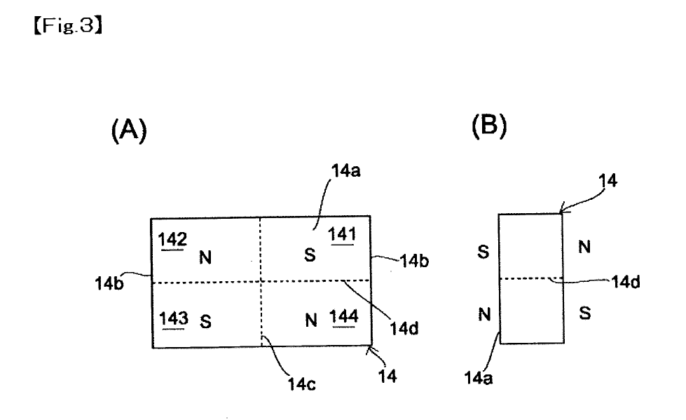

FIG. 1(A) is a plan view showing an objective lens drive device in accordance with an embodiment of the present invention and FIG. 1(B) is a side view showing the objective lens drive device shown in FIG. 1(A). FIG. 2(A) is a plan view showing the lens holder of the objective lens drive device shown in FIGS. 1(A) and 1(B), FIG. 2(B) is its side view, and FIG. 2(C) is its front view which is viewed from a tilt drive coil side. FIG. 3(A) is the front view of a tilt drive magnet used in the objective lens drive device shown in FIGS. 1(A) and 1(B) and FIG. 3(B) is the side view of the tilt drive magnet.

In FIGS. 1(A) and 1(B), the objective lens drive device 1 to which the present invention is applied is used in an optical head device which includes a prescribed optical system for performing recording or reproduction of information on or from an optical recording disk such as a CD or a DVD. Since a conventional well-known device frame may be used for the optical head device, its description is omitted. The objective lens drive device 1 includes an objective lens 2, a lens holder 3 holding the objective lens 2, a fixed side member 7 which supports the lens holder 3 with six wires 4 movably in a focusing direction (direction shown by the arrow “Fo”), in a tracking direction (direction shown by the arrow “Tr”), and in a tilt direction (direction shown by the arrow “Ti”), a focusing and tracking drive mechanism 8 which drives the lens holder 3 in the focusing direction “Fo” and in the tracking direction “Tr”, and a tilt drive mechanism 12 which drives the lens holder 3 in the tilt direction “Ti”.

The fixed side member 7 includes the wires 4 supporting the lens holder 3 on the tip end side of the wires 4, a holder support member 5 supporting the wires 4 on the base end side of the wires 4, and a yoke 6 which is a main body frame and is also a part of the focusing and tracking drive mechanism 8 and the tilt drive mechanism 12. The holder support member 5 is fixed on the yoke 6 with a fixing member such as an adhesive. The wire 4 may use a normal round bar-shaped wire, but a bar-shaped plate made of a thin plate whose cross-section is in a rectangular shape may be used as the wire 4. The bar-shaped plate may be easily constructed by punching a thin plate by means of press to be used as the wire 4.

The lens holder 3 is provided, as shown in FIGS. 2(A), 2(B) and 2(C), with a trapezoid shaped projecting part 3a on which the lens 2 is mounted at its center portion, and a body part 3c which is formed in a rectangular tube-shape whose one side is the base side 3b of the projecting part 3a. The lens holder 3 is supported with six wires 4 (see FIGS. 1(A) and 1(B)) which are disposed at three positions in the focusing direction on both sides of the tracking direction.

The six wires 4 are also used as an electric power feeding wire for a focusing drive coil 9, tracking drive coils 10, and a tilt drive coil 13 respectively. Therefore, the tip end portions of the wires 4 are soldered and fixed on a relay circuit board 17, which is fixed on either of both sides of the lens holder 3 in the tracking direction. The base end portions of the wires 4 are respectively soldered on the wiring pattern of a printed circuit board 16, which is mounted on the back face of the holder support member 5. On the printed circuit board 16 is soldered and fixed a flexible circuit board 18 for performing power feeding to the wires 4.

The focusing and tracking drive mechanism 8 is provided with a focusing drive coil 9 and two tracking drive coils 10, which are mounted on the lens holder 3, and a pair of focusing and tracking drive magnets 11 which are held on a holding part 6b that is cut and bent from the bottom face part 6a of the yoke 6. The focusing and tracking drive mechanism 8 is disposed at an approximately central portion of the lens holder 3. The focusing drive coil 9 is wound around in a rectangular shape and the outer peripheral side of three sides of the focusing drive coil 9 is fixed by adhesion or the like on an inner peripheral side of the body part 3c of the lens holder 3. The tracking drive coils 10 include two flat coils and are attached by adhesion on the outer face of the remaining one side except the above-mentioned three sides of the focusing drive coil 9.

The pair of the focusing and tracking drive magnets 11 are disposed in the inner side of the body part 3c of the lens holder 3 such that two drive magnets 11 interpose one side of the focusing drive coil 9 and the tracking drive coils 10 between the two drive magnets 11.

In the embodiment of the present invention, the tilt drive mechanism 12 is constructed of one piece of tilt drive coil 13 which is mounted on the lens holder 3 and one piece of tilt drive magnet 14 fixed on the holding part 6c (fixed side member) which is cut and bent from the bottom face part 6a of the yoke 6.

In the direction perpendicular to both the focusing direction “Fo” and the tracking direction “Tr”, that is, in the traverse direction in FIG. 1(A), the projecting part 3a holding the objective lens 2 is disposed on one end side of the lens holder 3 and the tilt drive mechanism 12 is arranged on the other end side of the lens holder 3, which is the opposite side of the projecting part 3a. In other words, the tilt drive mechanism 12 is arranged on the base end side of the wires 4 in FIGS. 1(A) and 1(B).

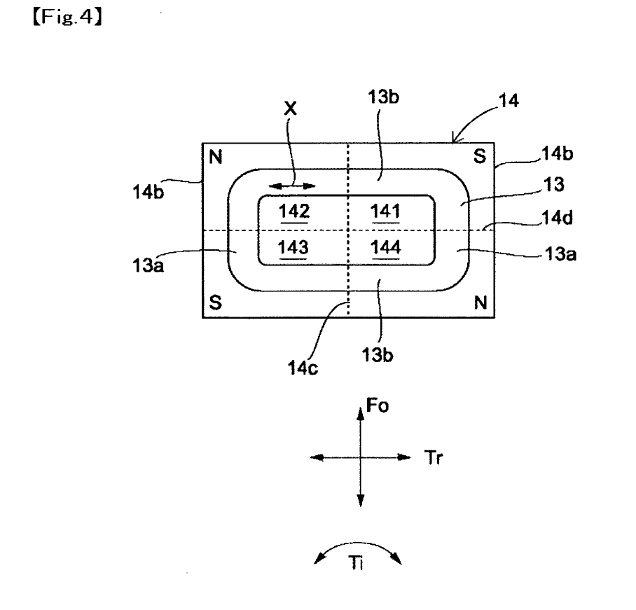

In the embodiment of the present invention, the tilt drive coil 13 is a flat coil which is wound around in a rectangular shape such that the opposing face to the tilt drive magnet 14 includes longitudinal side parts 13a (focusing direction) and traverse side parts 13b (tracking direction) as shown in FIG. 4. The tilt drive coil 13 is adhesively attached on the outer face 3d of the body part 3c of the lens holder 3 (see FIGS. 2(A) and 2(B)). In the present embodiment, the tilt drive coil 13 is wound around in a rectangular shape such that the longitudinal side part 13a (focusing direction) is a short side and the traverse side part 13b (tracking direction) is a long side.

The tilt drive magnet 14 is formed in a flat rectangular solid shape in which its longitudinal direction (focusing direction) in the drawing is set to be a short side as shown in FIG. 3(A). The tilt drive magnet 14 is fixed on the holding part 6c such that the opposing face 14a of the tilt drive magnet 14 is opposed to the tilt drive coil 13. The holding part 6c is formed so as to be cut and bent from the bottom face part 6a of the yoke 6 and is disposed on the outer peripheral side of the body part 3c of the lens holder 3.

FIG. 4 is an explanatory view showing an arrangement relationship between the tilt drive coil and the tilt drive magnet in which the objective lens drive device in accordance with the embodiment of the present invention is viewed from the tilt drive coil side.

As shown in FIG. 4, the tilt drive coil 13 and the tilt drive magnet 14 are oppositely arranged such that the longitudinal side parts 13a of the tilt drive coil 13 (focusing direction) and the short side parts 14b in the longitudinal direction of the tilt drive magnet 14 (focusing direction) are set to be approximately parallel.

The tilt drive magnet 14 includes four magnetized parts which are magnetized with four poles divided by a polarized line 14c formed in parallel with the longitudinal side part 13a (focusing direction) of the tilt drive coil 13 and a polarized line 14d formed in parallel with the traverse side part 13b (tracking direction). In other words, the tilt drive magnet 14 is polarized and has four poles magnetized, which are a first magnetized part 141, a second magnetized part 142, a third magnetized part 143 and a fourth magnetized part 144. Further, an N-pole and an S-pole are alternately magnetized in the first magnetized part 141 through the fourth magnetized part 144 along the winding direction X of the tilt drive coil 13. For example, the first magnetized part 141 is magnetized in an S-pole, the second magnetized part 142 is magnetized in an N-pole, the third magnetized part 143 is magnetized in an S-pole, and the fourth magnetized part 144 is magnetized in an N-pole.

The longitudinal side parts 13a and the traverse side parts 13b of the tilt drive coil 13 are arranged to oppose to the tilt drive magnet 14 such that each of the longitudinal side parts 13a and the traverse side parts 13b is disposed so as to extend over two magnetized parts among the first magnetized part 141 through the fourth magnetized part 144. In other words, in FIG. 4, for example, the longitudinal side part 13a on the right side in the drawing is oppositely disposed so as to extend over the first magnetized part 141 magnetized in the S-pole and the fourth magnetized part 144 magnetized in the N-pole. In this case, the polarized line 14d is located at the center position of the longitudinal side part 13a. Further, the traverse side part 13b on the upper side in the drawing is oppositely disposed so as to extend over the first magnetized part 141 magnetized in the S-pole and the second magnetized part 142 magnetized in the N-pole. In this case, the polarized line 14c is located at the center position of the traverse side part 13b. Similarly, the longitudinal side part 13a on the left side in the drawing is oppositely disposed so as to extend over the second magnetized part 142 and the third magnetized part 143 and the polarized line 14d is located at the center position of the longitudinal side part 13a. The traverse side part 13b on the under side in the drawing is oppositely disposed so as to extend over the third magnetized part 143 and the fourth magnetized part 144 and the polarized line 14c is located at the center position of the traverse side part 13b. The outer configuration of the tilt drive coil 13 is formed smaller than the outer configuration of the tilt drive magnet 14 as shown in FIG. 4.

The lens holder 3 is driven as described below in the tilt direction “Ti” (see FIG. 1) by means of the tilt drive mechanism 12 including the tilt drive coil 13 and the tilt drive magnet 14 which are arranged as described above.

In FIG. 4, when an electric current is supplied to the tilt drive coil 13 in a counterclockwise direction, a downward force (downward in the focusing direction) in the drawing is generated at the traverse side part 13b opposed to the first magnetized part 141 and the traverse side part 13b opposed to the fourth magnetized part 144, which are respectively located on the right side in the tracking direction. Also, an upward force (upward in the focusing direction) in the drawing is generated at the traverse side part 13b opposed to the second magnetized part 142 and the traverse side part 13b opposed to the third magnetized part 143, which are respectively located on the left side in the tracking direction. Therefore, the lens holder 3 is driven in the tilt or clockwise direction in the drawing by the downward force on the right side and the upward force on the left side in the tracking direction in FIG. 4.

On the other hand, when an electric current is supplied to the tilt drive coil 13 in a clockwise direction, the force in the reverse direction to the above-mentioned case is generated at the traverse side parts 13b, and thus the lens holder 3 is driven in the tilt or the counterclockwise direction in FIG. 4.

The tilt drive coil 13 may be wound around and formed in any rectangular shape. However, it is preferable that the tilt drive coil 13 is wound around in a rectangular shape such that the length of the longitudinal side part 13a differs from that of the traverse side part 13b, for example, the length of the traverse side part 13b is longer than that of the longitudinal side part 13a, to perform the tilt drive adequately.

As described above, in the objective lens drive device 1 in accordance with the embodiment of the present invention, the tilt drive magnet 14 includes the first magnetized part 141 through the fourth magnetized part 144, which are magnetized at four poles polarized by the polarized line 14c formed in parallel to the longitudinal side part 13a of the tilt drive coil 13 and the polarized line 14d formed in parallel to the traverse side part 13b. Further, the N-pole and the S-pole are alternately magnetized in the first magnetized part 141 through the fourth magnetized part 144 along the winding direction “X” of the tilt drive coil 13. In addition, the longitudinal side parts 13a and the traverse side parts 13b of the tilt drive coil 13 are arranged to oppose to the tilt drive magnet 14 such that each of the longitudinal side parts 13a and the traverse side parts 13b is disposed so as to extend over two magnetized parts among the first magnetized part 141 through the fourth magnetized part 144. Therefore, the tilt drive mechanism 12 can be realized by using only one piece of tilt drive magnet 14 without using a pair of separated tilt drive magnets which are disposed on both sides of the lens holder.

Further, the tilt drive mechanism 12 is constructed by using the tilt drive coil 13 includes a flat coil and the tilt drive magnet 14 includes a flat magnet. Moreover, the tilt drive magnet 14 is disposed in a space between the lens holder 3 and the holder support member 5, which is an unused space in the wire suspension type of objective lens drive device 1. Therefore, the miniaturization of the objective lens drive device 1 can be attained even when the tilt drive mechanism 12 is mounted.

In the embodiment of the present invention, the focusing and tracking drive mechanism 8 is arranged at an approximately center part of the lens holder 3. Therefore, the position of the center of gravity of the focusing and tracking drive mechanism 8 may be aligned with that of the objective lens drive device 1. Further, the objective lens 2 is held in the projecting part 3a of the lens holder 3 which is positioned on one side in a direction perpendicular to both the focusing direction “Fo” and the tracking direction “Tr” and the tilt drive mechanism 12 is disposed on the other side of the lens holder 3. Therefore, the tilt drive coil 13 constructing the tilt drive mechanism 12 can be used as a balance weight to adequately keep the balance of the objective lens drive device 1. As a result, stable focusing and tracking controls are performed.

Also, as described above, the objective lens 2 is held on the projecting part 3a, which is positioned on one side of the lens holder 3, and the tilt drive mechanism 12 is disposed on the other side of the lens holder 3. Therefore, the affection of heat generated in the tilt drive mechanism 12 to the optical system can be restrained.

In addition, since the tilt drive mechanism 12 is disposed on the base end side of the wires 4, the positional misalignment between the tilt drive coil 13 and the tilt drive magnet 14 can be reduced at the time of driving in the tilt direction “Ti”. Therefore, the appropriate tilt drive can be attained.

In the embodiment of the present invention, since the tilt drive coil 13, which is lighter than the tilt drive magnet 14, is mounted on the lens holder 3, the increase of the weight of the lens holder 3 can be restricted. As a result, the deterioration of the characteristics of the objective lens drive device 1 can be restricted.

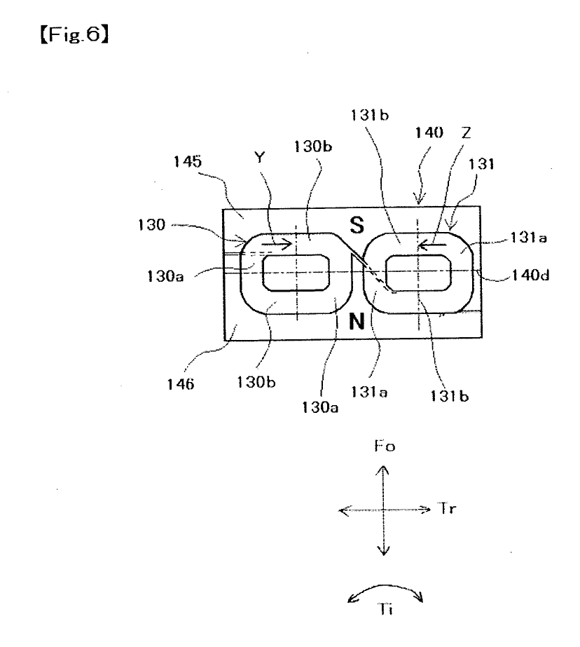

The present invention has been described in detail using the embodiments, but the present invention is not limited to the embodiments described above and many modifications can be made without departing from the present invention. For example, the tilt drive coil 13 in accordance with the embodiment of the present invention includes one piece of flat coil, which is wound around such that the opposing face to the tilt drive magnet 14 is formed in a rectangular shape having the longitudinal side parts 13a and the traverse side parts 13b. However, as shown in FIG. 6, the tilt drive coil 13 is formed of two flat coils to be constructed so as to be adjacently located in the tracking direction. FIG. 6 is an explanatory view showing an arrangement relationship between tilt drive coils and a tilt drive magnet in accordance with another embodiment of the present invention in which the objective lens drive device is viewed from the tilt drive coil side. In this case, tilt drive coils 130, 131, which are two flat coils, are formed by means that the tilt drive coil 130 on the left side in FIG. 6 is wound around in the Y-direction (clockwise) and the tilt drive coil 131 on the right side in the drawing is successively wound around in the Z-direction (counterclockwise). In other words, the tilt drive coil 130 on the left side and the tilt drive coil 131 on the right side are wound in the reverse direction each other. Therefore, when an electric current is supplied to the tilt drive coil 130 in the clockwise direction, the electric current is supplied to the tilt drive coil 131 in the counterclockwise direction. The respective tilt drive coils 130, 131 are wound around in a rectangular shape in which respective longitudinal side parts 130a, 131a are short sides and respective traverse side parts 130b, 131b are long sides as similar to the above-mentioned embodiment.

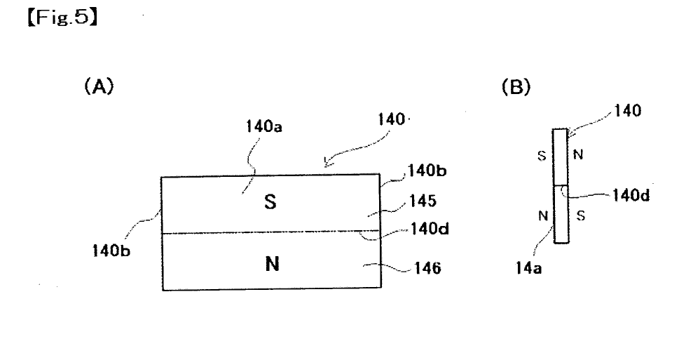

FIG. 5(A) is a front view of a tilt drive magnet in accordance with another embodiment of the present invention and FIG. 5(B) is a side view of the tilt drive magnet.

A tilt drive magnet 140 is formed, as shown in FIGS. 5(A) and 5(B), in a flat rectangular solid shape in which the side in the longitudinal direction in the drawing is set to be short. The tilt drive magnet 140 is fixed on the holding part 6c, which is cut and bent from the bottom face part 6a of the yoke 6, such that the opposing face 140a faces to the two tilt drive coils 130, 131. The two tilt drive coils 130, 131 and the tilt drive magnet 140 are oppositely arranged such that the respective longitudinal side parts 130a, 131a of the two tilt drive coils 130, 131 are set to be approximately parallel with the short side part 140b of the tilt drive magnet 140 in the longitudinal direction.

The tilt drive magnet 140 includes two magnetized parts which are polarized to be magnetized in two poles by the polarized line 140d formed in parallel with the respective traverse side parts 130b, 131b of the two tilt drive coils 130, 131. In other words, the tilt drive magnet 140 is polarized to be magnetized in two poles, which are a first magnetized part 145 and a second magnetized part 146. For example, in the embodiment of the present invention, the first magnetized part 145 is magnetized in an S-pole and the second magnetized part 146 is magnetized in an N-pole.

In addition, the two tilt drive coils 130, 131 are formed to be wound around in the reverse directions to each other and arranged to be opposed to the tilt drive magnet 140 such that the respective longitudinal side parts 130a, 131a of the tilt drive coils 130, 131 are extended over both the first magnetized part 145 and the second magnetized part 146. In other words, in FIG. 6, the respective longitudinal side parts 130a, 131a of the tilt drive coils 130, 131 are oppositely disposed so as to extend over the first magnetized part 145 magnetized in an S-pole and the second magnetized part 146 magnetized in an N-pole. Also, in FIG. 6, the respective traverse side parts 130b, 131b of the tilt drive coils 130, 131 on the upper side in the drawing are disposed to face the first magnetized part 145 magnetized in the S-pole. Further, the traverse side parts 130b, 131b on the under side in the drawing are disposed to face the second magnetized part 146 magnetized in the N pole. The outer configuration of the two tilt drive coils 130, 131 disposed side by side is, as shown in FIG. 6, formed smaller than the outer configuration of the tilt drive magnet 140.

The lens holder 3 is driven in the tilt direction “Ti” as described below by the two tilt drive coils 130, 131 and the tilt drive magnet 140 which are constructed as described above. In other words, in FIG. 6, when an electric current is supplied in a clockwise direction to the tilt drive coil 130 on the left side in the drawing, an upward force is generated in the traverse side part 130b on the upper side which is opposed to the first magnetized part 145 and in the traverse side part 130b on the under side which is opposed to the second magnetized part 146. Also, when the electric current is supplied to the tilt drive coil 130 on the left side in the clockwise direction, the electric current is supplied to the tilt drive coil 131 on the right side in the counterclockwise direction because the two tilt drive coils 130, 131 are formed to be wound around in the reverse directions to each other. Therefore, a downward force in the drawing is generated in the traverse side part 131b on the upper side of the tilt drive coil 131 on the right side which is opposed to the first magnetized part 145 and in the traverse side part 131b on the under side which is opposed to the second magnetized part 146. As a result, the lens holder 3 is clockwise driven in the tilt direction.

On the other hand, when an electric current is supplied to the tilt drive coil 130 on the left side in the counterclockwise direction, an electric current in the clockwise direction is supplied to the tilt drive coil 131 on the right side. In this case, forces in the reverse directions to the case described above are generated in the respective traverse side parts 130b, 131b of the tilt drive coils 130, 131 and thus the lens holder 3 is counterclockwise driven in the tilt direction.

In the embodiment shown in FIG. 3, one piece of the tilt drive magnet 14 is polarized and magnetized in four poles. However, four magnets respectively magnetized in a single pole are integrally combined to construct the tilt drive magnet 14 having four poles. Alternatively, four magnets respectively magnetized in a single pole are positioned in a close relation to one another to construct the tilt drive magnet 14 having four poles at one location in the objective lens drive device 1.

In the embodiment of the present invention, the tilt drive coil 13 is mounted on the lens holder 3. However, the tilt drive coil 13 may be mounted on the yoke 6 (fixed side member 7) and the tilt drive magnet 14 is mounted on the lens holder 3 so as to be opposed to each other. In this case, since the tilt drive magnet 14 is mounted on the lens holder 3, the position of the tilt drive magnet 14 varies and the lens holder 3 becomes heavy. Thus it may not be easy for the lens holder 3 to maintain its balance. However, the power feeding to the lens holder 3 for the tilt drive coil 13 is not required and thus only four wires 4 are needed. Accordingly, the device can be simplified to reduce the product cost.

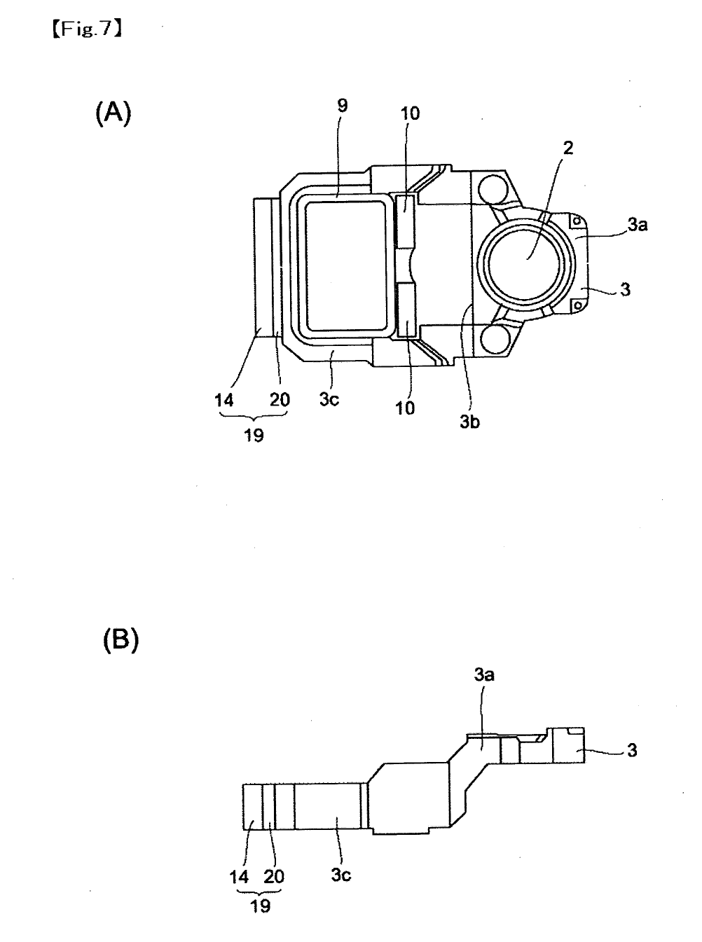

In addition, as shown in FIGS. 7(A) and 7(B), a damper device. 19 may be constructed to absorb the resonant vibration of the lens holder 3 by using the tilt drive magnet 14. In this case, it is preferable to mount the tilt drive magnet 14, which is a component part of the tilt drive mechanism 12, on the lens holder 3 through an elastic member 20 such as chloroprene rubber. Alternatively, when the tilt drive coil 13 is mounted on the lens holder 3, the tilt drive coil 13 may be mounted on the lens holder 3 through the elastic member 20 such as chloroprene rubber to construct the damper means.

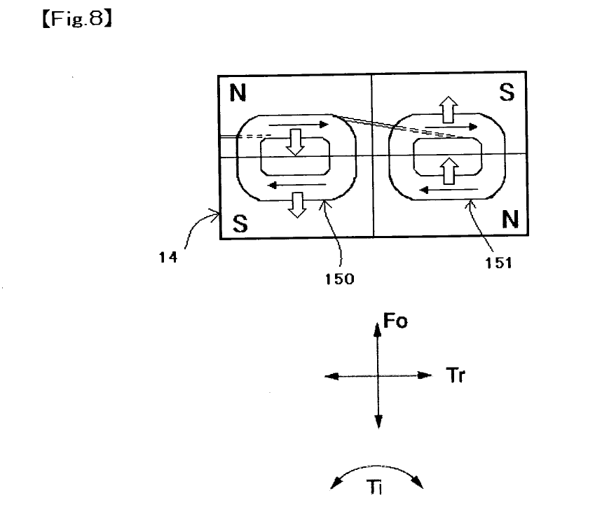

In the embodiment shown in FIG. 6, two pieces of flat coils are formed to be wound around in the reverse direction. Alternatively, two flat coils that are wound around in the same direction may be used. FIG. 8 shows an embodiment in which two tilt drive coils 150, 151 wound around in the same direction are used. In this case, the tilt drive magnet 14 shown in FIGS. 3(A) and 3(B) is used. In FIG. 8, when an electric current is supplied in the clockwise direction to the tilt drive coil 150 on the left side, a downward force is generated in the tilt drive coil 150 as described above. At this time, an electric current is supplied in the clockwise direction to the tilt drive coil 151 on the right side. However, the polarity of the tilt drive magnet 14 is reversed to that for the tilt drive coil 150, and thus an upward force is generated in the tilt drive coil 151 on the right side and the tilt of the lens holder 3 can be adjusted in the counterclockwise direction. When an electric current is supplied to the tilt drive coil 150 in the counterclockwise direction, operation is reversely performed to the above-mentioned case and the tilt of the lens holder 3 can be adjusted in the clockwise direction.

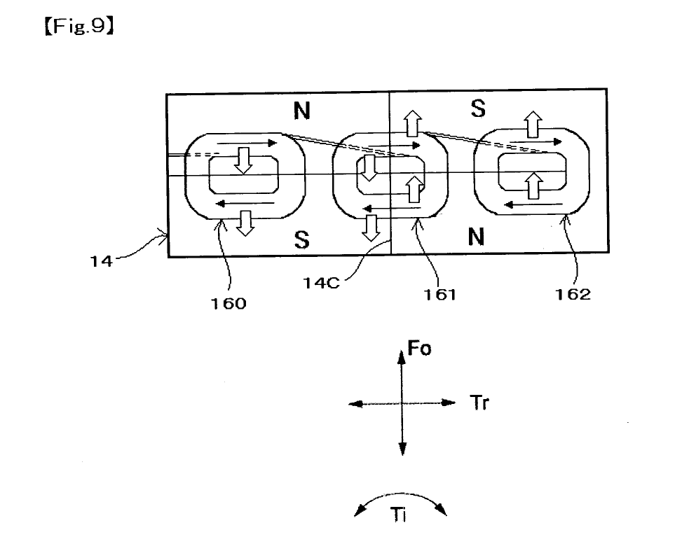

The example shown in FIG. 8 is the embodiment in which two flat coils wound around in the same direction are used. However, three or more flat coils wound around in the same direction may be used. FIG. 9 shows an embodiment in which a third flat coil is disposed between two flat coils shown in FIG. 8. In other words, in FIG. 9, three tilt drive coils 160, 161, 162 are used and the tilt drive magnet 14 shown in FIGS. 3(A) and 3(B) is used. In FIG. 9, the tilt drive coil 161 positioned at the center, which is the third coil, is disposed such that the polarized line 14c formed in the focusing direction is positioned at the center position of the tilt drive coil 161.

Therefore, the traverse side parts of the tilt drive coil 161 are positioned such that the length of the right side is equal to that of the left side with respect to the polarized line 14c. Also, the two tilt drive coils 160, 162 arranged on both sides in the tracking direction are also disposed at equal positions with respect to the polarized line 14c.

Accordingly, in FIG. 9, when an electric current is supplied to the tilt drive coil 160 in the clockwise direction, a downward force in the drawing is generated in the tilt drive coil 160 as similar to the case shown in FIG. 8. At this time, an electric current is supplied in the clockwise direction to the tilt drive coil 162 on the right side. However, the polarity of the tilt drive magnet 14 is reversed to that for the tilt drive coil 160, and thus an upward force is generated in the tilt drive coil 162. Also, the polarity of the tilt drive magnet 14 which faces the left side half of the tilt drive coil 161 is the same as that of the case for the tilt drive coil 160, and the polarity of the tilt drive magnet 14 which faces the right side half of the tilt drive coil 161 is the same as that of the case for the tilt drive coil 162. Therefore, a downward force is generated on the left side of the tilt drive coil 161 and an upward force is generated on the right side of the tilt drive coil 161. Accordingly, also in this case, similarly as the embodiment shown in FIG. 8, the tilt of the lens holder 3 can be adjusted in the counterclockwise direction. When an electric current is supplied to the tilt drive coils 160, 161, 162 in the counterclockwise direction, operation is reversely performed to the above-mentioned case and the tilt of the lens holder 3 can be adjusted in the clockwise direction.

In the embodiment shown in FIG. 3, the tilt drive magnet 14 is formed in a rectangular solid shape. However, the tilt drive magnet 14 may be formed in an other shape except the rectangular solid shape, for example, in a flat cylindrical shape in which at least the opposing face 14a is magnetized in four poles so as to be polarized by the polarized line 14c which is formed in parallel with the longitudinal side part 13a of the tilt drive coil 13, and by the polarized line 14d which is formed in parallel with the traverse side part 13b. Also, the magnetizing of the tilt drive magnet 14 is not limited to four poles. The tilt drive magnet 14 may be magnetized in multi-poles so as to be capable of tilt driving of the lens holder 3.

The tilt drive mechanism 12 in accordance with the embodiment of the present invention may be arranged on both sides of the lens holder 3 in the disk radial direction. In this case, the tilt of the lens holder 3 can be adjusted in the tangential direction of a disk.

In addition, in order to surely reduce a magnetic affection to the focusing drive coil 9 from the tilt drive magnet 14, the wall thickness of the body part 3c provided with the tilt drive coil 13 of the lens holder 3 may be formed thicker to keep away the focusing drive coil 9 from the tilt drive magnet 14. Alternatively, a yoke may be provided between the tilt drive coil 13 and the focusing drive coil 9.

In the objective lens drive device in accordance with the embodiment of the present invention, the tilt drive mechanism is constructed by only the tilt drive coil disposed at one place and the tilt drive magnet disposed at one place. Therefore, the tilt drive mechanism can be mounted on the objective lens drive device without preventing downsizing of the objective lens drive device. Accordingly, in a conventional optical head device which is provided with a wire suspension type of objective lens drive device having no tilt drive mechanism, the conventional objective lens drive device can be replaced by the objective lens drive device according to the embodiment of the present invention to construct an optical head device having a tilt drive mechanism. Also, when the tilt drive magnet is constructed of one piece of magnet, the miniaturization and cost reduction of the objective lens drive device may be attained.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An objective lens drive device, comprising:
an objective lens;
a lens holder which holds the objective lens;
a fixed side member which supports the lens holder with a plurality of wires in a movable manner;
a focusing and tracking drive mechanism which drives the lens holder in a focusing direction and in a tracking direction; and
a tilt drive mechanism which drives the lens holder in a tilt direction and which includes at least a tilt drive coil disposed at one place which is mounted on either side of the lens holder and the fixed side member and at least a tilt drive magnet disposed at one place so as to be opposed to the tilt drive coil on another side of the lens holder and the fixed side member.

2. The objective lens drive device according to claim 1, wherein the tilt drive magnet disposed at one place is one piece of magnet which is disposed so as to be opposed to the tilt drive coil.

3. The objective lens drive device according to claim 1, wherein the tilt drive magnet disposed at one place so as to be opposed to the tilt drive coil is constructed by using a plurality of mono-polar magnets which are integrated or positioned in a close relation.

4. The objective lens drive device according to claim 1, wherein the tilt drive coil disposed at one place is one piece of coil which is disposed so as to be opposed to the tilt drive magnet.

5. The objective lens drive device according to claim 1, wherein the tilt drive coil disposed at one place is constructed by using a plurality of coils so as to be opposed to the tilt drive magnet disposed at one place.

6. The objective lens drive device according to claim 1, wherein
the tilt drive coil is wound around such that an opposing face to the tilt drive magnet is formed in a rectangular shape which has longitudinal side parts and traverse side parts,
the tilt drive magnet is provided with four magnetized parts on an opposing face to the tilt drive coil, which are polarized and magnetized in four poles by polarized lines which are parallel with the longitudinal side part and the traverse side part such that an N-pole and an S-pole are alternately magnetized in the four magnetized parts, and
the longitudinal side part and the traverse side part are respectively arranged so as to extend over two magnetized parts among the four magnetized parts.

7. The objective lens drive device according to claim 6, wherein the traverse side part of the tilt drive coil is arranged such that the polarized line which is parallel with the longitudinal side part of the tilt drive magnet is positioned at a center position of the traverse side part in the tracking direction.

8. The objective lens drive device according to claim 1, wherein
the tilt drive coil includes a traverse side part which is formed in parallel with the tracking direction in which the lens holder is driven,
the tilt drive magnet includes an N-pole and an S-pole which are magnetized in the focusing direction in which the lens holder is driven, and
an electric current is supplied to the traverse side part such that forces in reverse directions in the focusing direction in which the lens holder is driven are relatively generated between the tilt drive magnet and the tilt drive coil in the traverse side part of the tilt drive coil to drive the lens holder in a tilt direction.

9. The objective lens drive device according to claim 8, wherein
the tilt drive coil is one piece of coil which is wound around such that an opposing face to the tilt drive magnet is formed in a rectangular shape which has longitudinal side parts and the traverse side part,
the tilt drive magnet is provided with four magnetized parts on an opposing face to the tilt drive coil, which are polarized and magnetized in four poles by polarized lines which are parallel with the longitudinal side part and the traverse side part,
the magnetized parts of the tilt drive magnet corresponding to both sides of the traverse side part in the tracking direction of the tilt drive coil are magnetized to be in reverse polarities in the focusing direction in which the lens holder is driven, and
when an electric current is supplied to the one piece of coil, forces in reverse directions with respect to the focusing direction in which the lens holder is driven are relatively generated on both sides of the traverse side part in the tracking direction of the tilt drive coil between the tilt drive magnet and the tilt drive coil.

10. The objective lens drive device according to claim 8, wherein
an opposing face of the tilt drive magnet to the tilt drive coil comprises two magnetized parts which are polarized and magnetized in two poles by a polarized line that is parallel with the traverse side part,
the tilt drive coil comprises two coils which have the traverse side parts so as to be opposed to the tilt drive magnet and are arranged side by side in the tracking direction,
the traverse side parts of the two coils arranged so as to be opposed to a magnetized part of same polarity are electrically connected so that electric currents in reverse directions are supplied to the traverse side parts of the two coils, and
when electric currents in reverse directions are respectively supplied to the traverse side parts of the two coils, forces in reverse directions with respect to the focusing direction in which the lens holder is driven are relatively generated on both sides of the traverse side parts of the two tilt drive coils between the tilt drive magnet and the two tilt drive coils.

11. The objective lens drive device according to claim 8, wherein
the tilt drive magnet comprises four magnetized parts on an opposing face to the tilt drive coil, which are polarized and magnetized in four poles by polarized lines which are parallel with the longitudinal side part and the traverse side part,
the tilt drive coil comprises two coils, each of which is wound around such that an opposing face to the tilt drive magnet is formed in a rectangular shape which has longitudinal side parts and traverse side parts, and which are arranged side by side in the tracking direction such that magnetized parts polarized by the polarized line parallel with the longitudinal side part of the tilt drive coil are respectively opposed to the two coils,
the traverse side parts of the two coils are connected to each other so that electric currents in same direction are supplied to the traverse side parts of the two coils, and
the magnetized parts of the tilt drive magnet which are opposed to the traverse side parts of the two coils are magnetized in reverse polarities in the focusing direction in which the lens holder is driven.

12. The objective lens drive device according to claim 11, further comprising a third coil arranged between the two coils in the tracking direction, which is wound around such that an opposing face to the tilt drive magnet is formed in a rectangular shape which has longitudinal side parts and traverse side parts,
wherein the traverse side part of the third coil is arranged such that the polarized line which is parallel with the longitudinal side part of the tilt drive magnet is positioned at a center position of the traverse side part in the tracking direction and that an electric current is supplied in the same direction as that of the two coils.

13. The objective lens drive device according to claim 1, wherein the objective lens is held on one end side of the lens holder and the tilt drive mechanism is disposed on the other end side of the lens holder.

14. The objective lens drive device according to claim 13, wherein one of the tilt drive magnet and the tilt drive coil of the tilt drive mechanism is held on the other end side of the lens holder.

15. The objective lens drive device according to claim 13, further comprising a damper means mounted on the lens holder for restricting resonant vibration of the lens holder, which includes an elastic member mounted on the lens holder and the tilt drive coil or the tilt drive magnet mounted on the elastic member.

16. The objective lens drive device according to claim 1, wherein the tilt drive coil is mounted on the lens holder.

17. An optical head device provided with the objective lens drive device according to claim 1.

18. An objective lens drive device, comprising:
an objective lens;
a lens holder which holds the objective lens;
a fixed side member which supports the lens holder with a plurality of wires in a movable manner;
a focusing and tracking drive mechanism which drives the lens holder in a focusing direction and in a tracking direction; and
means for driving the lens holder in a tilt direction and which includes at least a tilt drive coil disposed at one place which is mounted on either side of the lens holder and the fixed side member and at least a tilt drive magnet disposed at one place so as to be opposed to the tilt drive coil on another side of the lens holder and the fixed side member.

19. The objective lens drive device according to claim 18, further comprising a damper device mounted on the lens holder for restricting resonant vibration of the lens holder, which includes an elastic member mounted on the lens holder and the tilt drive coil or the tilt drive magnet mounted on the elastic member.
